(19) United States
(12) Patent Application Publication
(10) Pub. No.: US 2014/0278744 A1
(43) Pub. Date: Sep. 18, 2014

(54) SYSTEMS AND METHODS FOR RECOMMENDING COMPETITOR SETS

(71) Applicant: MASTERCARD INTERNATIONAL INCORPORATED, Purchase, NY (US)

(72) Inventors: Walter Lo Faro, Chesterfield, MO (US); Christopher J. Merz, Wildwood, MO (US)

(73) Assignee: MASTERCARD INTERNATIONAL INCORPORATED, Purchase, NY (US)

(21) Appl. No.: 13/834,229

(22) Filed: Mar. 15, 2013

(51) Int. Cl. G06Q 30/02

(52) U.S. Cl. CPC G06Q 30/0201
USPC 705/7.29

(57) ABSTRACT

A computer system for recommending potential competitor merchants to a subscriber merchant and/or a market analyst is provided. The computer system includes a memory device in communication with a processor. The processor is programmed to receive transaction information for a plurality of cardholders from a payment network. The transaction information includes data relating to purchases made by the cardholders at a plurality of merchants. The processor may receive subscriber merchant preference information for at least one of the merchants input by the cardholder. The computer system determines a merchant rank for each merchant based on the received transaction information and/or the subscriber merchant preference information, and determines a neutral merchant rank and a merchant score for each merchant. After ranking, a ranked list of potential competitor merchants is generated for presentation to a subscriber merchant and/or a market analyst for further analysis.

### BACKGROUND OF THE DISCLOSURE

The field of the disclosure relates generally to methods and systems for recommending merchants and, more particularly, to network-based methods and systems for recommending a competitor set of merchants to a merchant requesting such a competitor set, wherein the competitor set is based on payment transactions initiated at the competitor set of merchants and at the requestor merchant.

In the current economic climate, competition between merchants has become increasingly fierce. In order to remain viable, a merchant should periodically review its performance relative to its competition. One way of doing so is to review various parameters of their transactions to the same or similar parameters of comparable transactions performed by their competitors. Various known methods exist that enable merchants to identify potential competitors. For example, Internet websites exist that enable merchants to conduct keyword-based searches for other businesses, as well as to identify consumer reviews of such other businesses, as well as reviews of their own businesses.

However, defining and identifying entities that are truly a set of appropriate competitors for any particular merchant present challenges. For example, an entity may technically be a competitor to a merchant, in that the entity in question may market and sell the same or similar products or services. However, inasmuch as business entities may compete through various channels of trade, such as retail sales via brick-and-mortar establishments, versus online sales, a particular entity may be a serious competitor to a merchant in only a few or just one of many possible areas of competition. In addition, information regarding potential competitors needs to be current; otherwise the information is likely to be of little use, or even misleading to a merchant and/or market analyst, for purposes of evaluating the performance of the merchant. Therefore, prompt, reliable and accurate information is needed in order to appropriately identify a merchant's competitors, and the relevant transactions performed by the competitors, which establish them as competitors.

### BRIEF DESCRIPTION OF THE DISCLOSURE

In one embodiment, a competitor identifier computer system for developing a set of merchants that are competitors to a subscriber merchant for presentation to a market analyst is provided. The system includes a memory device for storing data; and a processor in communication with the memory device. The processor is programmed to receive payment card transaction information for payment cardholders from the payment network, the payment card transaction information including data relating to a plurality of purchases made by the plurality of cardholders at a plurality of different merchants, the purchases satisfying a first criterion. The processor is further programmed to receive merchant rating information. The processor is further programmed to receive merchant descriptive information. The processor is further programmed to determine location information of each of the plurality of different merchants relative to at least one of a predetermined selectable location and a location of a subscriber merchant. The processor is further programmed to determine a set of competitor merchants from the plurality of different merchants using the received payment card transaction information, the received merchant rating information, the received merchant descriptive information, and the determined location information. The processor is further programmed to display the set of competitor merchants to at least one of the subscriber merchant and a market analyst.

In another embodiment, a computer-implemented method for developing a set of merchants that are competitors to a subscriber merchant, for presentation to a market analyst is provided. The method uses a merchant analytic (MA) computer system, wherein the MA computer system is in communication with a memory device. The method includes receiving, at the MA computer system, payment card transaction information for payment cardholders from the payment network, the payment card transaction information including data relating to a plurality of purchases made by the plurality of cardholders at a plurality of different merchants, the purchases satisfying a first criterion. The method further includes receiving, at the MA computer system, merchant rating information. The method further includes receiving, at the MA computer system, merchant descriptive information. The method further includes determining location information of each of the plurality of different merchants relative to at least one of a predetermined selectable location and a location of a subscriber merchant. The method further includes determining a set of competitor merchants from the plurality of different merchants using the received payment card transaction information, the received merchant rating information, the received merchant descriptive information, and the determined location information. The method further includes displaying the set of competitor merchants to at least one of the subscriber merchant and a market analyst.

In yet another embodiment, one or more computer-readable storage media having computer-executable instructions embodied thereon for developing a set of merchants that are competitors to a subscriber merchant for presentation to a market analyst are provided. When executed by at least one processor, said computer-executable instructions cause the processor to receive payment card transaction information for payment cardholders from the payment network, the payment card transaction information including data relating to a plurality of purchases made by the plurality of cardholders at a plurality of different merchants, the purchases satisfying a first criterion. The computer-executable instructions further cause the processor to receive merchant rating information. The computer-executable instructions further cause the processor to receive merchant descriptive information. The computer-executable instructions further cause the processor to determine location information of each of the plurality of different merchants relative to at least one of a predetermined selectable location and a location of a subscriber merchant. The computer-executable instructions further cause the processor to determine a set of competitor merchants from the plurality of different merchants using the received payment card transaction information, the received merchant rating information, the received merchant descriptive information, and the determined location information. The computer-executable instructions further cause the processor to display the set of competitor merchants to at least one of the subscriber merchant and a market analyst.

### BRIEF DESCRIPTION OF THE DRAWINGS

FIGS. 1-10 show example embodiments of the methods and systems described herein.

FIG. 1 is a schematic diagram illustrating an example multi-party payment card industry system for enabling ordinary payment-by-card transactions in which merchants and card issuers do not necessarily have a one-to-one relationship.

FIG. 2 is a simplified block diagram of an example merchant analytic computer system including a plurality of computer devices including a user device having a merchant competitor identifier application in accordance with one example embodiment of the present invention.

FIG. 3 is an expanded block diagram of an example embodiment of a server architecture of the merchant analytic computer system including the plurality of computer devices in accordance with one example embodiment of the present invention.

FIG. 4 illustrates an example configuration of a client system shown in FIGS. 2 and 3.

FIG. 5 illustrates an example configuration of a server system shown in FIGS. 2 and 3.

FIG. 6 is a block diagram showing an operation of the merchant analytic computer system shown in FIG. 2.

FIG. 7 is a flow diagram of an example method of recommending merchants to a cardholder using the merchant analytic computer system shown in FIG. 2 coupled to a user device having a merchant competitor identifier application stored thereon.

FIG. 8 is a block diagram showing the process by which the merchant analytic computer system creates a matrix of merchant associations.

FIG. 9 is a screen shot displayed within the web-based interface shown in FIG. 2 showing a list of potential competitor merchants generated by the merchant analytic computer system shown in FIG. 2.

FIG. 10 is an alternative screen shot displayed within the web-based interface shown in FIG. 2 showing a list of potential competitor merchants, as well as a geographical map showing locations of the potential competitor merchants.

### DETAILED DESCRIPTION OF THE DISCLOSURE

The following detailed description illustrates embodiments of the invention by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure.

Some merchants (hereinafter “subscriber merchants”) are known to subscribe to the services of market analysts for purposes of receiving information and analysis, relating to the merchants' performance relative to their competitors. A market analyst compares a set of transactions of a subscriber merchant to sets of transactions of a set of competitor merchants in order to assess the performance of the subscriber merchant. The comparison uses data developed from past transaction histories of transaction payment card holders. The disclosure is described as applied to an example embodiment, namely, methods and systems for providing subscriber merchants and/or market analysts (collectively referred to herein as “recipients”) sets of competitor businesses for making accurate assessments of a subscriber merchant's performance relative to those competitor businesses. More specifically, the disclosure describes a merchant analytic computer system (also referred to as “MA computer system”) configured to collect transaction data associated with a plurality of payment cardholders, and identify at least one potential competitor merchant to the recipients for purposes of conducting a market analysis for the subscriber merchant.

The MA computer system is configured to recommend at least one potential competitor business to a recipient. In the example embodiment, the MA computer system is configured for use with a payment card processing network such as, for example, a payment network. The MA computer system includes a memory device and a processor in communication with the memory device and is programmed to communicate with the payment network to receive transaction information for a plurality of cardholders. The payment network is configured to process payment card transactions between the subscriber merchant and its acquirer bank, potential competitor businesses and their acquirer banks, and the cardholders and their issuer banks. Transaction information includes data relating to purchases made by cardholders at various merchants during a predetermined time period and within a predetermined geographical region. In some embodiments, the plurality of purchases made by the cardholders are related to each other as being in the same market segment, for example, but not limited to, a restaurant dining segment. While restaurant dining is the segment used in describing example embodiments herein, the present disclosure is not limited thereto, and the claims are not so limited. Specifically, the transaction analyzed by the MA computer system can be any payment transaction performed at any merchant, not just restaurant-type merchants. Thus, the process and system described herein can define a competitor set for any type of merchant. In some embodiments, the plurality of purchases made by the cardholders are related to each other as being in the same channel of trade, such as retail sales at brick-and-mortar establishments.

In the example embodiment, for cardholders that transact at two or more merchants of the plurality of merchants during the predetermined time period, the MA computer system creates a matrix of merchant associations for the plurality of merchants indicating the number of transactions between each merchant combination and the cardholders. For each cardholder that has transacted at multiple merchants within the specified segment, the MA computer system updates the association matrix with the transaction information. More specifically, a counter is associated with each merchant within the matrix. For each pair of merchants patronized by each cardholder, the MA computer system increments the counter associated with those merchants. Accordingly, the more often a cardholder of the plurality of cardholders transacts with a merchant, the more associations that merchant will obtain within the matrix.

In an example embodiment, the MA computer system may also be programmed to receive subscriber merchant preference information from a subscriber merchant. Subscriber merchant preference information may be inputted to the MA computer system by a subscriber merchant via an interface presented on a website maintained, for example, by the MA computer system. In an alternative embodiment, the subscriber merchant may use an app provided by the MA computer system to the subscriber merchant, to input preference information. In one embodiment, subscriber merchant preference information is obtained by the MA computer system analyzing historical transaction data associated with cardholders who have transacted business with the subscriber merchant. The MA computer system may also obtain transaction information for those same cardholders, regarding other merchants that may represent potential competitors to the subscriber merchant. In an embodiment, the subscriber merchant may select at least one merchant from a list of merchants presented via the web-based interface. The list of merchants is generated by the MA computer system based on a geographical region selectable by the subscriber merchant. In an example embodiment, subscriber merchant preference information may include results from surveys, Internet website scraping, solicited and unsolicited opinion data, satisfaction scale input, and/or other ranking acquisition methods. In an example embodiment, subscriber merchant preference information may include any item of information that may or may not be directed to a specific potential competitor merchant, that one of ordinary skill may deem relevant towards a determination of whether a potential competitor merchant is truly a competitor of the subscriber merchant.

Based on the subscriber merchant preference information, the MA computer system creates a preference vector. The preference vector represents a measurement of the subscriber merchant's preferences for one merchant relative to at least one other merchant of the plurality of merchants, as potential competitors. In one embodiment, subscriber merchant preferences are associated with a score for each merchant. For example, the preference may be measured on a scale of 1 to 10, or on a 5-star scale. In another embodiment, a value of one is associated with each merchant selected by the subscriber merchant from a list and aggregated. In a further embodiment, each merchant is associated with a magnitude based on a gratuity amount inferred from the historical transaction information. Regardless of the preference measurement chosen, in some embodiments, the MA computer system normalizes the preference vector such that each merchant is given a value, and the values for the plurality of merchants sums to one, which provides a scaled preference vector that is biased based on the subscriber merchant preferences.

In an example embodiment, the MA computer system applies the preference vector to the matrix of merchant associations to determine a merchant ranking vector. The merchant ranking vector is associated with the subscriber merchant preference information and includes a merchant rank associated with each merchant of the plurality of merchants. The merchant rank represents a measure of general popularity of each merchant relative to the plurality of merchants that is adjusted according to the subscriber merchant preference information.

The MA computer system then creates and applies a neutral preference vector to the matrix of merchant associations to determine a neutral merchant ranking vector. The neutral preference vector includes generic preference information that is equal for each merchant of the plurality of merchants. The neutral merchant ranking vector includes a neutral merchant rank associated with each merchant of the plurality of merchants. The neutral merchant rank represents a measure of general popularity of each merchant relative to the plurality of merchants.

The MA computer system compares the neutral merchant ranking vector to the merchant ranking vector to determine a merchant score vector for the subscriber merchant. The merchant score vector includes a merchant score indicating the difference between the merchant rank and the neutral merchant rank associated with each merchant of the plurality of merchants. The merchant score represents a measure of recommendation for each merchant of the plurality of merchants determined by the MA computer system for the subscriber merchant.

In the example embodiment, the MA computer system sorts the merchant score vector in descending order based on the merchant score associated with each merchant of the plurality of merchants. More specifically, in the example embodiment, the merchant having the highest merchant score is placed first in the merchant score vector and the merchant having the lowest merchant score is placed last in the merchant score vector. The MA computer system then provides a set of potential competitors to the subscriber merchant, using the web-based interface, wherein the list is based on the sorted merchant score vector.

A technical effect of the systems and methods described herein is achieved by performing at least one of the following steps: (a) receiving, at the MA computer system, payment card transaction information for payment cardholders from the payment network, the payment card transaction information including data relating to a plurality of purchases made by the plurality of cardholders at a plurality of different merchants, the purchases satisfying a first criterion; (b) receiving, at the MA computer system, merchant rating information; (c) receiving, at the MA computer system, merchant descriptive information; (d) determining location information of each of the plurality of different merchants relative to at least one of a predetermined selectable location and a location of a subscriber merchant; (e) determining a set of competitor merchants from the plurality of different merchants using the received payment card transaction information, the received merchant rating information, the received merchant descriptive information, and the determined location information; (f) displaying the set of competitor merchants to at least one of the subscriber merchant and a market analyst; (g) receiving, at the MA computer system, subscriber merchant preference information for at least one merchant of the plurality of merchants; (h) determining, at the MA computer system, a merchant rank for each merchant of the plurality of merchants based on the received transaction information and the subscriber merchant preference information; (i) determining, at the MA computer system, a neutral merchant rank for each merchant of the plurality of merchants based on the received transaction information and neutral merchant preferences associated with the plurality of merchants; (j) determining, at the MA computer system, a merchant score for each merchant of the plurality of merchants by comparing the merchant rank to the neutral merchant rank; (k) creating, at the MA computer system, a matrix of merchant associations for the plurality of merchants indicating a number of transactions between each merchant combination and the cardholders, wherein each merchant combination includes as one of the merchants said subscriber merchant; (l) creating a preference vector representing a level of a preference of the subscriber merchant for one merchant relative to at least one other merchant; (m) applying the preference vector to the matrix of merchant associations to determine a merchant ranking vector, wherein the merchant ranking vector is associated with the subscriber merchant preference information and includes the merchant rank associated with each merchant of the plurality of merchants; (n) applying a neutral preference vector to the matrix of merchant associations to determine a neutral merchant ranking vector, wherein the neutral preference vector includes generic preference information that is equal for each merchant of the plurality of merchants, and wherein the neutral merchant ranking vector includes the neutral merchant rank associated with each merchant of the plurality of merchants; (o) comparing the neutral merchant ranking vector to the merchant ranking vector to determine a merchant score vector for the subscriber merchant, wherein the merchant score vector includes the merchant score associated with each merchant of the plurality of merchants; (p) sorting the plurality of merchants in descending order based on the determined merchant scores; (q) providing a list of potential competitor merchants to the subscriber merchant, wherein the list is based on the sorted merchant scores.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transactions card can be used as a method of payment for performing a transaction.

In one embodiment, a computer program is provided, and the program is embodied on a computer readable medium. In an example embodiment, the system is executed on a single computer system, without requiring a connection to a sever computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the invention by way of example and not by way of limitation. It is contemplated that the invention has general application to processing financial transaction data by a third party in industrial, commercial, and residential applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present invention are not intended to be interpreted as excluding the existence of additional embodiments that also incorporate the recited features.

FIG. 1 is a schematic diagram illustrating an example multi-party transaction card industry system 20 for enabling ordinary payment-by-card transactions in which merchants 24 and card issuers 30 do not need to have a one-to-one special relationship. In the example embodiment, one of merchants 24 is a subscriber merchant 23 (also shown in FIG. 6). Embodiments described herein may relate to a transaction card system, such as a credit card payment system using the MasterCard® interchange network (which is a type of payment network). The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 22, who uses the transaction card to tender payment for a purchase from a merchant 24, such as subscriber merchant 23. To accept payment with the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card, merchant 24 requests authorization from a merchant bank 26 for the amount of the purchase. The request may be performed over the telephone, but is usually performed through the use of a point-of-sale terminal, which reads cardholder's 22 account information from a magnetic stripe, a chip, or embossed characters on the transaction card and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using a payment network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns goods after the transaction has been captured, a “credit” is generated. Payment network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, payment network 28, and issuer bank 30. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction. In the example embodiment, when cardholder 22 purchases travel, such as airfare, a hotel stay, and/or a rental car, at least partial itinerary information is transmitted during the clearance process as transaction data. When payment network 28 receives the itinerary information, payment network 28 routes the itinerary information to database 120.

For debit card transactions, when a request for a personal identification number (PIN) authorization is approved by the issuer, cardholder's account 32 is decreased. Normally, a charge is posted immediately to cardholder's account 32. The payment card association then transmits the approval to the acquiring processor for distribution of goods/services or information, or cash in the case of an automated teller machine (ATM).

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and payment network 28, and then between payment network 28 and merchant bank 26, and then between merchant bank 26 and merchant 24.

FIG. 2 is a simplified block diagram of an example processing system 100 including a plurality of computer devices including a user device having a merchant competitor identifier application in accordance with one example embodiment of the present invention. In the example embodiment, system 100 may be used for performing payment-by-card transactions received as part of processing the financial transaction. In addition, system 100 is a payment processing system that includes a merchant analytic (MA) computer system 121 configured to provide merchant recommendation data to a merchant computing device 118 via a web-based interface 119 as described herein. As described below in more detail, MA computer system 121 is configured to receive transaction data and subscriber merchant preference information, and recommend a list of potential competitor merchants to a subscriber merchant via interface 119 based on the received information.

More specifically, in the example embodiment, system 100 includes a server system 112, and a plurality of client sub-systems, also referred to as client systems 114, connected to server system 112. In one embodiment, client systems 114 are computers including a web browser, such that server system 112 is accessible to client systems 114 using the Internet or some other network connection configured for processing payment card transactions. Client systems 114 are interconnected to the Internet through many interfaces including a network, such as a local area network (LAN) or a wide area network (WAN), dial-in-connections, cable modems, and special high-speed Integrated Services Digital Network (ISDN) lines. Client systems 114 could be any device capable of interconnecting to the Internet including a web-based phone, PDA, or other web-based connectable equipment.

System 100 also includes point-of-sale (POS) terminals 115, which may be connected to client systems 114 and may be connected to server system 112. POS terminals 115 are interconnected to the Internet through many interfaces including a network, such as a LAN or a WAN, dial-in-connections, cable modems, wireless modems, and special high-speed ISDN lines. POS terminals 115 could be any device capable of interconnecting to the Internet and including an input device capable of reading information from a consumer's financial transaction card.

A database server 116 is connected to database 120, which contains information on a variety of matters, as described below in greater detail. In one embodiment, centralized database 120 is stored on server system 112 and can be accessed by potential users at one of client systems 114 by logging onto server system 112 through one of client systems 114 or via logging onto interface 119 via merchant computing device 118. In an alternative embodiment, database 120 is stored remotely from server system 112 and may be non-centralized.

Database 120 may include a single database having separated sections or partitions or may include multiple databases, each being separate from each other. Database 120 may store transaction data generated as part of sales activities conducted over the processing network including data relating to merchants, account holders or customers, issuers, acquirers, purchases made. Database 120 may also store account data including at least one of a cardholder name, a cardholder address, an account number, and other account identifier. Database 120 may also store merchant data including a merchant identifier that identifies each merchant registered to use the network, and instructions for settling transactions including merchant bank account information. Database 120 may also store purchase data associated with items being purchased by a cardholder from a merchant, and authorization request data.

As described above, system 100 includes merchant computing device 118, which is configured to communicate with at least one of POS terminals 115, client systems 114 and server system 112. In the example embodiment, merchant computing device 118 is associated with or controlled by a subscriber merchant seeking recommendations regarding potential competitor merchants having customers that are cardholders that make purchases using system 100. Merchant computing device 118 is interconnected to the Internet through many interfaces including a network, such as a LAN or WAN, dial-in-connections, cable modems, wireless modems, and special high-speed ISDN lines. Merchant computing device 118 may be any device capable of interconnecting to the Internet including a web-based phone, smartphone, PDA, iPhone® (iPhone is a registered trademark of Apple, Incorporated located in Cupertino, Calif.), Android® device (Android is a registered trademark of Google Incorporated located in Mountain View, Calif.), and/or any device capable of executing stored computer-readable instructions. Merchant computing device 118 is configured to communicate with POS terminals 115 using various outputs including, for example, Bluetooth communication, radio frequency communication, near field communication, network-based communication, and the like.

In the example embodiment, merchant computing device 118 communicates with MA computer system 121 via logging onto web-based interface 119 that is part of a subscription website maintained by MA computer system 121. More specifically, interface 119 enables subscriber merchant 23, through merchant computing device 118, to transmit subscriber merchant transaction information and subscriber merchant preference information input to MA computer system 121 either directly or through server 112. Transaction information may include a payment card number, an account number and/or any other data relating to purchases made by a cardholder 22.

In the example embodiment, one of client systems 114 may be associated with acquirer bank 26 (shown in FIG. 1) while another one of client systems 114 may be associated with issuer bank 30 (shown in FIG. 1). POS terminal 115 may be associated with a subscriber merchant 23 (shown in FIG. 6), a participating merchant 24 (shown in FIG. 1) or may be a computer system and/or mobile system used by a cardholder making an on-line purchase or payment. Server system 112 may be associated with payment network 28. In the example embodiment, server system 112 is associated with a network interchange, such as payment network 28, and may be referred to as an interchange computer system. Server system 112 may be used for processing transaction data. In addition, client systems 114 and/or POS terminal 115 may include a computer system associated with at least one of an online bank, a bill payment outsourcer, an acquirer bank, an acquirer processor, an issuer bank associated with a transaction card, an issuer processor, a remote payment system, and/or a biller. Further, in the example embodiment, MA computer system 121 is included in or is in communication with server system 112. In various embodiments, MA computer system 121 may be associated with a standalone processor or may be associated with a separate third party provider in a contractual relationship with payment network 28 and configured to perform the functions described herein. Accordingly, each party involved in processing transaction data are associated with a computer system shown in system 100 such that the parties can communicate with one another as described herein.

FIG. 3 is an expanded block diagram of an example embodiment of a server architecture of a processing system 122 including other computer devices in accordance with one embodiment of the present invention. Components in system 122, identical to components of system 100 (shown in FIG. 2), are identified in FIG. 3 using the same reference numerals as used in FIG. 2. System 122 includes server system 112, client systems 114, and POS terminals 115. Server system 112 further includes database server 116, a transaction server 124, a web server 126, a fax server 128, a directory server 130, and a mail server 132. A storage device 134 is coupled to database server 116 and directory server 130. Servers 116, 124, 126, 128, 130, and 132 are coupled in a LAN 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., account holders, customers, auditors, developers, consumers, merchants, acquirers, issuers, etc., 146 using an ISP Internet connection 148. The communication in the example embodiment is illustrated as being performed using the Internet, however, any other WAN type communication can be utilized in other embodiments, i.e., the systems and processes are not limited to being practiced using the Internet. In addition, and rather than WAN 150, local area network 136 could be used in place of WAN 150.

In the example embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well. In the example embodiment, MA computer system 121 is in communication with server system 112 and is in communication with client systems 114, POS terminals 115, and/or merchant computing device 118.

FIG. 4 illustrates an example configuration of a user system 202 operated by a user 201, such as subscriber merchant 23 (shown in FIG. 6). User system 202 may include, but is not limited to, client systems 114, 138, 140, and 142, POS terminal 115, user device 118 that may access interface 119 (shown in FIG. 2), workstation 154, and manager workstation 156. In the example embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively coupleable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively coupleable to a remote device such as server system 112. Communication interface 225 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from server system 112. A client application allows user 201 to interact with a server application from server system 112.

FIG. 5 illustrates an example configuration of a server system 275 such as server system 112 (shown in FIGS. 2 and 3). Server system 275 may include, but is not limited to, database server 116, application server 124, web server 126, fax server 128, directory server 130, and mail server 132.

Server system 275 includes a processor 280 for executing instructions. Instructions may be stored in a memory area 285, for example. Processor 280 may include one or more processing units (e.g., in a multi-core configuration) for executing instructions. The instructions may be executed within a variety of different operating systems on the server system 275, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 280 is operatively coupled to a communication interface 290 such that server system 275 is capable of communicating with a remote device such as a user system or another server system 275. For example, communication interface 290 may receive requests from client system 114 via the Internet, as illustrated in FIGS. 2 and 3.

Processor 280 may also be operatively coupled to a storage device 134. Storage device 134 is any computer-operated hardware suitable for storing and/or retrieving data. In some embodiments, storage device 134 is integrated in server system 275. For example, server system 275 may include one or more hard disk drives as storage device 134. In other embodiments, storage device 134 is external to system 275 and may be accessed by a plurality of server systems 275. For example, storage device 134 may include multiple storage units such as hard disk drives or solid state drives in a redundant array of inexpensive disks (RAID) configuration. Storage device 134 may include a storage area network (SAN) and/or a network attached storage (NAS) system.

In some embodiments, processor 280 is operatively coupled to storage device 134 via a storage interface 295. Storage interface 295 is any component capable of providing processor 280 with access to storage device 134. Storage interface 295 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 280 with access to storage device 134.

Memory area 285 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are by way of example only, and are thus not limiting as to the types of memory usable for storage of a computer program.

FIG. 6 is a block diagram showing an operation of MA computer system 121 (shown in FIG. 2). MA computer system 121 is configured receive transaction data for a plurality of cardholders transacting with a plurality of merchants 24, including subscriber merchant 23, receive subscriber merchant preferences, and output a list of potential competitor merchants identified by MA computer system 121 based on the received data. In the example embodiment, MA computer system 121 is in communication with a payment network, such as payment card payment network 28 (shown in FIG. 1), for receiving transaction data. MA computer system 121 includes a memory device 600 and a processor 602 in communication with memory device 600.

In the example embodiment, MA computer system 121 is programmed to communicate with payment network 28 to receive transaction information 604 for a plurality of payment cardholders. Payment network 28 is configured to process payment card transactions between merchants 24 associated with merchant banks 26, and cardholders 22 associated with issuer banks 30. Payment card transaction information 604 includes data relating to purchases made by a plurality of cardholders 22 at a plurality of merchants 24 during a predetermined time period and within a predetermined geographical region or some other criterion applied to the data. In some embodiments, the plurality of purchases made by cardholder 22 are related to each other as being in the same market segment, for example, but not limited to a dining segment, an events segment, a night club segment, or an activities segment. The dining segment may include all purchases made at restaurants and food service merchants. The events segment may include all purchases that relate to concerts, sporting, or cultural events. The night club segment may include dance clubs and casinos. The activities segment may include amusement parks, and attractions. In an example embodiment, details of the segment(s) of interest may be defined by subscriber merchant 23.

In an example embodiment, MA computer system 121 may also be also programmed to receive subscriber merchant preference information 606 that may be used by MA computer system 121 in its ranking of potential competitor merchants, as described herein. In one embodiment, subscriber merchant preference information 606 is obtained by MA computer system 121 by analyzing historical transaction information from subscriber merchant 23 relating to transactions with cardholders 22. Subscriber merchant preference information 606 may further include results from surveys, Internet website scraping, solicited and unsolicited opinion data, satisfaction scale input, and/or other ranking acquisition methods. Moreover, subscriber merchant preference information 606 may include any information relating to any aspect of an experience with a merchant 24, such as subscriber merchant 23.

MA computer system 121 is further programmed to receive merchant descriptive information 612 from subscriber merchant 23, a potential competitor merchant 24, and/or from a third party service 614. Merchant descriptive information 612 includes information relating to location, hours of operation, upcoming events, entertainment provided, and advertising and promotional information. Merchant descriptive information 612 is stored in database 120 (shown in FIG. 2) associated with payment network 28. In the example embodiment, MA computer system 121 is also programmed to determine location information for each of the plurality of potential competitor merchants 24 relative to a predetermined selectable location and/or a location of subscriber merchant 23.

In the example embodiment, MA computer system 121 is also programmed to determine a merchant score for each of the plurality of potential competitor merchants 24 using the received transaction information 604 and, optionally, the received subscriber merchant preference information 606. The merchant score indicates a difference between a merchant rank and a neutral merchant rank associated with each merchant of the plurality of merchants, as will be described in more detail herein. The merchant score represents a level of closeness as a competitor (e.g., on a scale from 1 to 100 with 100 being the closest competitor for a particular subscriber merchant 23) determined for a particular subscriber merchant 23. In an alternate embodiment, MA computer system 121 is programmed to determine merchant scores for the plurality of merchants using at least one manually selected merchant 24 selected by subscriber merchant 23 from a list of the plurality of merchants 24. After determining the merchant scores of merchants 24, MA computer system 121 sorts the plurality of merchants 24 in descending order based on the merchant scores and provides a list 620 of potential competitor merchants to merchant computing device 118, where it is displayed to subscriber merchant 23 via interface 119, as is described in further detail herein.

FIG. 7 is a flow diagram of an example method 700 of recommending at least one merchant of a plurality of merchants to a cardholder using a computer device coupled to a database. In the example embodiment, method 700 may be implemented by MA computer system 121 (shown in FIG. 2).

In the example embodiment, the MA computer system receives 702 transaction information for a plurality of payment cardholders from a payment network. The payment network is configured to process payment card transactions between a merchant and a cardholder. The transaction information includes data relating to purchases made by a plurality of cardholders at a plurality of merchants during a predetermined time period and/or within a predetermined geographical region. In some embodiments, the purchases made by the plurality of cardholders are related to each other as being in the same market segment, for example, but not limited to a dining segment, an events segment, a night club segment, or an activities segment.

In the example embodiment, for cardholders that transact at two or more merchants of the plurality of merchants, the MA computer system creates 704 a matrix of merchant associations for the plurality of merchants indicating the number of transactions between each merchant combination and the cardholders. In the example embodiment, merchant associations are limited to associations between subscriber merchant 23, and potential competitor merchants 24 with which each cardholder has transacted business. For each cardholder that has transacted at multiple merchants within the specified segment, the MA computer system updates the association matrix with the transaction information. More specifically, a counter is associated with each merchant within the matrix. For each pair, comprised of a merchant 24 visited by each cardholder, and subscriber merchant 23, the MA computer system increments 706 the counter associated with those merchants. Accordingly, the more often a cardholder of the plurality of cardholders transacts with a merchant, the more associations that merchant will obtain within the matrix.

For example, FIG. 8 is a block diagram showing the process by which the MA computer system creates a matrix of associations between a subscriber merchant 23 and a plurality of potential competitor merchants 24. Initially, the MA computer system determines which merchants associated with a specified segment are located within a predetermined region (e.g., a city or a specified radius from a location) specified by subscriber merchant 23 and inputs those merchants into a matrix 800. In the example embodiment, matrix 800 includes merchants 24 (“a,” “b,” “c,” “d,” “e,” and “f” in FIG. 8), and subscriber merchant 23 (“S” in FIG. 8). The MA computer system obtains transaction data 802 for cardholders that have transacted with merchants 24, and subscriber merchant 23 during a specified time period 804 or window of observation 804. The transaction data is provided by a payment network.

Using the transaction data, the MA computer system populates matrix 800 to obtain a matrix of merchant associations 806. In the example embodiment, a cardholder must have transacted with one or more of merchants 24 (merchants a-f), and subscriber merchant 23 (merchant S) to be counted in matrix 806. This facilitates reducing an effect of cardholder bias toward a single merchant. In the example embodiment, for each pair of a potential competitor merchant 24 and subscriber merchant 23 that a cardholder has transacted with, the MA computer system increments a counter associated with the merchant pair. For example, because 1^{st} cardholder transacted with merchants a and S, increments a value stored in block (a, S) of matrix 806 by a value of one. As shown in transaction data 802, both 2^{nd} and 4^{th} cardholders transacted with merchants b and S. Accordingly, the MA computer system increments block (b, S) by a value of two in matrix 806. Once complete with all of the transaction data, matrix of merchant associations 806 provides a measure of the associations between each pair of a competitor merchant 24 and subscriber merchant 23, based on how often each cardholder transacts with both merchants of the pair. Additionally, matrix of merchant associations 806 illustrates a popularity of each merchant relative to the other merchants based on historical data, free from cardholder bias.

Referring back to FIG. 7, after creating the merchant association matrix, in an example embodiment, MA computer system may receive 708 subscriber merchant preference information from subscriber merchant 23. Subscriber merchant preference information is inputted to the MA computer system by subscriber merchant 23 via interface 119 (shown in FIGS. 2 and 3). In one embodiment, subscriber merchant preference information is obtained by the MA computer system by analyzing historical transaction data provided by subscriber merchant 23. Subscriber merchant preference information may also include results from surveys, Internet website scraping, solicited and unsolicited opinion data, satisfaction scale input, and/or other ranking acquisition methods. Moreover, subscriber merchant preference information may relate to an overall experience with a merchant.

In the example embodiment, based on the subscriber merchant preferences, the MA computer system creates 710 a preference vector. The preference vector represents a measurement of the subscriber merchant's preference for one merchant relative to at least one other merchant of the plurality of merchants. In one embodiment, subscriber merchant preferences are associated with a score for each merchant. For example, the preference may be measured on a scale of 1 to 10, or on a 5-star scale. In another embodiment, a value of one is associated with each merchant selected by the subscriber merchant from a list and aggregated. In a further embodiment, each merchant is associated with a magnitude based on a gratuity amount inferred from the historical transaction information. Regardless of the preference measurement chosen, the MA computer system normalizes the preference vector such that each merchant is given a value, and the values for the plurality of merchants sums to one, which provides a scaled preference vector that is biased based on the subscriber merchant preferences.

After obtaining the preference vector, the MA computer system applies 712 the preference vector to the matrix of merchant associations to determine a merchant ranking vector. The merchant ranking vector is associated with the subscriber merchant preference information and includes a merchant rank associated with each merchant of the plurality of merchants. The merchant rank represents a level or a measure of general popularity of each merchant relative to the plurality of merchants that is adjusted according to the subscriber merchant preference information.

The MA computer system then creates and applies 714 a neutral preference vector to the matrix of merchant associations to determine a neutral merchant ranking vector. The neutral preference vector includes generic preference information that is equal for each merchant of the plurality of merchants. The neutral merchant ranking vector includes a neutral merchant rank associated with each merchant of the plurality of merchants. The neutral merchant rank represents a measure of general popularity of each merchant relative to the plurality of merchants.

The MA computer system compares 716 the neutral merchant ranking vector to the merchant ranking vector to determine a merchant score vector for the subscriber merchant. The merchant score vector includes a merchant score indicating the difference between the merchant rank and the neutral merchant rank associated with each merchant of the plurality of merchants. The merchant score represents a measure of closeness as a competitor to subscriber merchant 23, for each merchant 24 of the plurality of merchants determined by the MA computer system for subscriber merchant 23.

In the example embodiment, the MA computer system sorts 718 the merchant score vector in descending order based on the merchant score associated with each merchant of the plurality of merchants. More specifically, in the example embodiment, the merchant having the highest merchant score is placed first in the merchant score vector and the merchant having the lowest merchant score is placed last in the merchant score vector. In one embodiment, the MA computer system associates a relative score with each merchant to show each merchant's relative rank increase as related to the plurality of merchants. The MA computer system then provides 720 a list of potential competitor merchants 24 to the subscriber merchant 23, and/or to a market analyst retained by subscriber merchant 23, wherein the list is based on the sorted merchant score vector.

To generate a list of potential competitor merchants 24, in the example embodiment, MA computer system 121 is programmed to determine location information of each of the plurality of different merchants 24 relative to a predetermined selectable location and/or a location of subscriber merchant 23. For example, a subscriber merchant 23 that uses merchant computing device 118 (shown in FIG. 2) may define a geographical radius within which a set of potential competitor merchants 24 can be drawn. Alternatively, a subscriber merchant 23 can define a specific geographical area or region that may not be related specifically to distance from subscriber merchant 23.

FIG. 9 is a screen shot displayed within interface 119 (shown in FIG. 2) on merchant computing device 118 (shown in FIGS. 2 and 3) showing a list 900 of recommended potential competitor merchants generated by MA computer system 121 (shown in FIG. 2). In the example embodiment, list 900 is determined using the methods described in FIG. 7. Once the rankings are determined, ranked list 900 is formatted and displayed to subscriber merchant 23 on merchant computing device 118 (shown in FIG. 2) via interface 119. In an alternate embodiment, ranked list 900 is displayed to an analyst retained by subscriber merchant 23 (either via transmission by subscriber merchant 23 to the analyst, or by the analyst directly accessing interface 119, upon receipt of suitable permissions and/or login information obtained from subscriber merchant 23 and/or MA computer system 121).

FIG. 10 is an alternative example screen shot 950 that may be displayed within interface 119 (shown in FIG. 2) showing to a subscriber merchant 23 both a list 952 of potential competitor merchants generated by MA computer system 121 (shown in FIG. 2), and a geographical map 954 that shows the locations of the competitor merchants in list 952. In an example embodiment, map 954 may also show the location 956 of subscriber merchant 23. In screen shot 950, list 952 may include not only competitor merchants 24 identified via MA computer system 121, but also competitor merchants identified through other means, such as competitors previously specified by subscriber merchant 23, and other potential competitors identified through search engines, for example. In an example embodiment, competitors that were identified through more than one mechanism, such as a competitor identified both by MA computer system 121, and through either or both of subscriber merchant 23 and/or a search engine may be shown highlighted, using a color code to indicate which additional sources also identified the potential competitor merchant.

After the list of potential competitor merchants has been developed, the list (such as lists 900 or 952) may be accessed by subscriber merchant 23 via system 121. Alternatively, lists 900 or 952 may be accessed by and/or transmitted to a market analyst retained by subscriber merchant 23, along with the underlying cardholder transaction data, for further processing and analysis, for example to develop detailed market reports that detail performance of subscriber merchant 23 relative to competitor merchants 24. In an example embodiment, the analysis may result in the creation of an aggregated composite competitor merchant, performance details of which may be used as a benchmark against which a subscriber merchant may assess its own business performance. In an alternative example embodiment, details of performance of specific competitor merchants may be provided.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications or code) include machine instructions for a programmable processor, and can be implemented in a high-level procedural and/or object-oriented programming language, and/or in assembly/machine language. As used herein, the terms “machine-readable storage medium” and “computer-readable storage medium” refer to any computer program product, apparatus and/or device (e.g., magnetic discs, optical disks, memory, Programmable Logic Devices (PLDs)) used to provide machine instructions and/or data to a programmable processor, including a machine-readable storage medium that receives machine instructions as a machine-readable signal. The term “machine-readable signal” refers to any signal used to provide machine instructions and/or data to a programmable processor. The machine-readable storage medium and computer-readable medium do not include transitory signals.

The above-described embodiments of a method and system of ranking merchants according to a subscriber merchant's preferences and cardholder purchasing behaviors provides a cost-effective and reliable means for identifying competitor merchants to a subscriber merchant. As a result, the methods and systems described herein facilitate leveraging a payment network's assets to facilitate a subscriber merchant's ability to gauge its performance relative to a set of competitor merchants in a cost-effective and reliable manner.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A competitor identifier computer system for developing a set of merchants that are competitors to a subscriber merchant for presentation to a market analyst, said system comprising:
a memory device for storing data; and
a processor in communication with the memory device, said processor programmed to:
receive payment card transaction information for payment cardholders from the payment network, the payment card transaction information including data relating to a plurality of purchases made by the plurality of cardholders at a plurality of different merchants, the purchases satisfying a first criterion;
receive merchant rating information;
receive merchant descriptive information;
determine location information of each of the plurality of different merchants relative to at least one of a predetermined selectable location and a location of a subscriber merchant;
determine a set of competitor merchants from the plurality of different merchants using the received payment card transaction information, the received merchant rating information, the received merchant descriptive information, and the determined location information; and
display the set of competitor merchants to at least one of the subscriber merchant and a market analyst.

2. A computer system in accordance with claim 1, wherein said processor is programmed to receive subscriber merchant preference information for at least one merchant of the plurality of merchants.

3. A computer system in accordance with claim 2, wherein said processor is programmed to determine a merchant rank for each merchant of the plurality of merchants based on the received transaction information and the subscriber merchant preference information.

4. A computer system in accordance with claim 3, wherein said processor is programmed to determine a neutral merchant rank for each merchant of the plurality of merchants based on the received transaction information and neutral merchant preferences associated with the plurality of merchants.

5. A computer system in accordance with claim 4, wherein said processor is programmed to determine a merchant score for each merchant of the plurality of merchants by comparing the merchant rank to the neutral merchant rank.

6. A computer system in accordance with claim 5, wherein said processor is further programmed to create a matrix of merchant associations for the plurality of merchants indicating a number of transactions between each merchant combination and the cardholders, wherein each merchant combination includes as one of the merchants said subscriber merchant.

7. A computer system in accordance with claim 6, wherein said processor is further programmed to create the matrix for cardholders that transact at two or more merchants of the plurality of merchants during a predetermined time period.

8. A computer system in accordance with claim 7, wherein said processor is further programmed to:
determine the merchant rank for each merchant;
create a preference vector representing a level of a preference of the subscriber merchant for one merchant relative to at least one other merchant; and
apply the preference vector to the matrix of merchant associations to determine a merchant ranking vector, wherein the merchant ranking vector is associated with the subscriber merchant preference information and includes the merchant rank associated with each merchant of the plurality of merchants.

9. A computer system in accordance with claim 8, wherein said processor is further programmed to determine a neutral merchant rank by applying a neutral preference vector to the matrix of merchant associations to determine a neutral merchant ranking vector, wherein the neutral preference vector includes generic preference information that is equal for each merchant of the plurality of merchants, and wherein the neutral merchant ranking vector includes the neutral merchant rank associated with each merchant of the plurality of merchants.

10. A computer system in accordance with claim 9, wherein said processor is further programmed to determine the merchant score by comparing the neutral merchant ranking vector to the merchant ranking vector to determine a merchant score vector for the subscriber merchant, wherein the merchant score vector includes the merchant score associated with each merchant of the plurality of merchants.

11. A computer system in accordance with claim 10, wherein said processor is further programmed to:
sort the plurality of merchants in descending order based on the determined merchant scores; and
provide a list of potential competitor merchants to the subscriber merchant, wherein the list is based on the sorted merchant scores.

12. A computer system in accordance with claim 1, wherein to satisfy the first criterion, the purchases occur during a predetermined time period and within a predetermined geographical region.

13. A computer system in accordance with claim 1, wherein the plurality of merchants are associated with the same market segment.

14. A computer-implemented method for developing a set of merchants that are competitors to a subscriber merchant, for presentation to a market analyst, said method using a merchant analytic (MA) computer system, wherein the MA computer system is in communication with a memory device, said method comprising:
receiving, at the MA computer system, payment card transaction information for payment cardholders from the payment network, the payment card transaction information including data relating to a plurality of purchases made by the plurality of cardholders at a plurality of different merchants, the purchases satisfying a first criterion;
receiving, at the MA computer system, merchant rating information;
receiving, at the MA computer system, merchant descriptive information;
determining location information of each of the plurality of different merchants relative to at least one of a predetermined selectable location and a location of a subscriber merchant;
determining a set of competitor merchants from the plurality of different merchants using the received payment card transaction information, the received merchant rating information, the received merchant descriptive information, and the determined location information; and
displaying the set of competitor merchants to at least one of the subscriber merchant and a market analyst.

15. A method in accordance with claim 14, said method further comprising receiving, at the MA computer system, subscriber merchant preference information for at least one merchant of the plurality of merchants.

16. A method in accordance with claim 15, said method further comprising determining, at the MA computer system, a merchant rank for each merchant of the plurality of merchants based on the received transaction information and the subscriber merchant preference information.

17. A method in accordance with claim 16, said method further comprising determining, at the MA computer system, a neutral merchant rank for each merchant of the plurality of merchants based on the received transaction information and neutral merchant preferences associated with the plurality of merchants.

18. A method in accordance with claim 17, said method further comprising determining, at the MA computer system, a merchant score for each merchant of the plurality of merchants by comparing the merchant rank to the neutral merchant rank.

19. A method in accordance with claim 18, said method further comprising creating, at the MA computer system, a matrix of merchant associations for the plurality of merchants indicating a number of transactions between each merchant combination and the cardholders, wherein each merchant combination includes as one of the merchants said subscriber merchant.

20. A method in accordance with claim 19, wherein creating the matrix further comprising creating the matrix for cardholders that transact at two or more merchants of the plurality of merchants during a predetermined time period.

21. A method in accordance with claim 20, said method further comprising:
determining the merchant rank for each merchant;
creating a preference vector representing a level of a preference of the subscriber merchant for one merchant relative to at least one other merchant; and
applying the preference vector to the matrix of merchant associations to determine a merchant ranking vector, wherein the merchant ranking vector is associated with the subscriber merchant preference information and includes the merchant rank associated with each merchant of the plurality of merchants.

22. A method in accordance with claim 21, said method further comprising applying a neutral preference vector to the matrix of merchant associations to determine a neutral merchant ranking vector, wherein the neutral preference vector includes generic preference information that is equal for each merchant of the plurality of merchants, and wherein the neutral merchant ranking vector includes the neutral merchant rank associated with each merchant of the plurality of merchants.

23. A method in accordance with claim 22, said method further comprising comparing the neutral merchant ranking vector to the merchant ranking vector to determine a merchant score vector for the cardholder, wherein the merchant score vector includes the merchant score associated with each merchant of the plurality of merchants.

24. A method in accordance with claim 23, said method further comprising:
sorting the plurality of merchants in descending order based on the determined merchant scores; and
providing a list of potential competitor merchants to the subscriber merchant, wherein the list is based on the sorted merchant scores.

25. A method in accordance with claim 14, wherein to satisfy the first criterion, the purchases occur during a predetermined time period and within a predetermined geographical region.

26. A method in accordance with claim 14, wherein the plurality of merchants are associated with the same market segment.

27. One or more computer-readable storage media having computer-executable instructions embodied thereon for developing a set of merchants that are competitors to a subscriber merchant for presentation to a market analyst, wherein when executed by at least one processor, said computer-executable instructions cause the processor to:
receive payment card transaction information for payment cardholders from the payment network, the payment card transaction information including data relating to a plurality of purchases made by the plurality of cardholders at a plurality of different merchants, the purchases satisfying a first criterion;
receive merchant rating information;
receive merchant descriptive information;
determine location information of each of the plurality of different merchants relative to at least one of a predetermined selectable location and a location of a subscriber merchant;
determine a set of competitor merchants from the plurality of different merchants using the received payment card transaction information, the received merchant rating information, the received merchant descriptive information, and the determined location information; and
display the set of competitor merchants to at least one of the subscriber merchant and a market analyst.

28. The computer-readable storage media in accordance with claim 27, wherein said computer-executable instructions cause said processor to receive subscriber merchant preference information for at least one merchant of the plurality of merchants.

29. The computer-readable storage media in accordance with claim 28, wherein said computer-executable instructions cause said processor to determine a merchant rank for each merchant of the plurality of merchants based on the received transaction information and the subscriber merchant preference information.

30. The computer-readable storage media in accordance with claim 29, wherein said computer-executable instructions cause said processor to determine a neutral merchant rank for each merchant of the plurality of merchants based on the received transaction information and neutral merchant preferences associated with the plurality of merchants.

31. The computer-readable storage media in accordance with claim 30, wherein said computer-executable instructions cause said processor to determine a merchant score for each merchant of the plurality of merchants by comparing the merchant rank to the neutral merchant rank.

32. The computer-readable storage media in accordance with claim 31, wherein said computer-executable instructions cause said processor to create a matrix of merchant associations for the plurality of merchants indicating a number of transactions between each merchant combination and the cardholders, wherein each merchant combination includes as one of the merchants said subscriber merchant.

33. The computer-readable storage media in accordance with claim 32, wherein the computer-executable instructions cause said processor to create the matrix for cardholders that transact at two or more merchants of the plurality of merchants during a predetermined time period.

34. The computer-readable storage media in accordance with claim 33, wherein the computer-executable instructions cause said processor to:
determine the merchant rank for each merchant;
create a preference vector representing a level of a preference of the subscriber merchant for one merchant relative to at least one other merchant; and
apply the preference vector to the matrix of merchant associations to determine a merchant ranking vector, wherein the merchant ranking vector is associated with the subscriber merchant preference information and includes the merchant rank associated with each merchant of the plurality of merchants.

35. The computer-readable storage media in accordance with claim 34, wherein said computer-executable instructions cause said processor to determine a neutral merchant rank by applying a neutral preference vector to the matrix of merchant associations to determine a neutral merchant ranking vector, wherein the neutral preference vector includes generic preference information that is equal for each merchant of the plurality of merchants, and wherein the neutral merchant ranking vector includes the neutral merchant rank associated with each merchant of the plurality of merchants.

36. The computer-readable storage media in accordance with claim 35, wherein said computer-executable instructions cause said processor to determine the merchant score by comparing the neutral merchant ranking vector to the merchant ranking vector to determine a merchant score vector for the subscriber merchant, wherein the merchant score vector includes the merchant score associated with each merchant of the plurality of merchants.

37. The computer-readable storage media in accordance with claim 36, wherein said computer-executable instructions cause said processor to:
sort the plurality of merchants in descending order based on the determined merchant scores; and
provide a list of potential competitor merchants to the subscriber merchant, wherein the list is based on the sorted merchant scores.

38. The computer-readable storage media in accordance with claim 27, wherein to satisfy the first criterion, the purchases occur during a predetermined time period and within a predetermined geographical region.

39. The computer-readable storage media in accordance with claim 27, wherein the plurality of merchants are associated with the same market segment.
